(19) United States
(12) Patent Application Publication
(10) Pub. No.: US 2025/0308828 A1
(43) Pub. Date: Oct. 2, 2025

(54) STAGGERING-CONTACT AIRGAP MECHANISM

(71) Applicant: Siemens Industry, Inc., Alpharetta, GA (US)

(72) Inventors: Huy Nguyen, Sugar Hill, GA (US); Guang Yang, Johns Creek, GA (US); Mark I. Shmukler, Duluth, GA (US)

(73) Assignee: Siemens Industry, Inc., Alpharetta, GA (US)

(21) Appl. No.: 18/621,315

(22) Filed: Mar. 29, 2024

(51) Int. Cl. H01H 71/12; H01H 71/24; H01H 71/52

(52) U.S. Cl. CPC H01H 71/123; H01H 71/2463; H01H 71/521; H01H 71/523

(57) ABSTRACT

A direct current (DC) solid state circuit breaker mechanism (SSCBM) includes a first switch assembly configured to selectively close a first airgap and open the first airgap, and a second switch assembly configured to selectively close a second airgap and open the second airgap. The second switch assembly is adjustable into an unlatched position to open the second airgap at a first time. Unlatching the second switch assembly initiates adjustment of the first switch assembly into an unlatched position to open the first airgap at a second time that is later than the first time.

### FIELD

The present disclosure relates generally to DC solid state circuit breakers, and more particularly, to a staggering-contact airgap mechanism that can be implemented in a DC solid state circuit breaker.

### BACKGROUND

Circuit breakers are typically used to protect downstream circuits and equipment in various environments, such as residential homes or buildings, hospitals, industrial settings such as factories, etc., in case of an electrical fault, such as in an overcurrent or a short circuit situation. Generally, circuit breakers carry current from a power supply to a load under normal operating conditions and break, or interrupt, the current in order to protect the load from being exposed to high levels of current when the electrical fault occurs. One type of circuit breaker referred to as a solid state circuit breaker (SSCB), uses semiconductor switching elements, such as transistor switches, and software algorithms to detect and interrupt fault currents substantially faster than a traditional residential circuit breaker. However, there are still needs for physical separation in the circuit between the line side and the load side when the breaker is tripped or turned off.

### SUMMARY

According to a non-limiting embodiment of the present disclosure, a direct current (DC) solid state circuit breaker mechanism (SSCBM) comprises a first switch assembly configured to selectively close a first airgap and open the first airgap, and a second switch assembly configured to selectively close a second airgap and open the second airgap. The second switch assembly is adjustable into an unlatched position to open the second airgap at a first time. Unlatching the second switch assembly initiates adjustment of the first switch assembly into an unlatched position to open the first airgap at a second time that is later than the first time.

According to another non-limiting embodiment of the present disclosure a direct current (DC) solid state circuit breaker mechanism (SSCBM) comprises a first switch assembly configured to selectively close a first airgap and open the first airgap, and a second switch assembly configured to selectively close a second airgap and open the second airgap. The first switch assembly includes a first armature configured to be adjusted into a first unlatched position which unlatches it from a first cradle to open the first airgap. The second switch assembly includes a trip linkage configured to adjust a second armature into a second unlatched position which unlatches it from a second cradle to open the second airgap at a first time period. The adjustment of the second armature into the second unlatched position induces adjustment of the first armature into the first unlatched position to open the first airgap at a second time period that is later than the first time period.

### BRIEF DESCRIPTION OF THE DRAWINGS

Objects, features, and advantages of the present invention will become apparent upon reading the following description in conjunction with the drawing figures, in which:

FIG. 1 is a disassembled view of a staggering-contact airgap mechanism according to a non-limiting embodiment of the present disclosure;

FIG. 2 depicts a second switch assembly of the staggering-contact airgap mechanism shown in FIG. 1 operating in a first operating state (ON position);

FIG. 3 depicts the second switch assembly transitioning from the first operating state (ON position) to a second operating state (OFF position);

FIG. 4 depicts the second switch assembly transitioning from the first operating state (ON position) to a second operating state (OFF position);

FIG. 5 depicts the second switch assembly as it continues transitioning to the second operating state (OFF position);

FIG. 6 depicts a first switch assembly of the staggering-contact airgap mechanism shown in FIG. 1 transitioning from a first operating state (ON position) to a second operating state (OFF position);

FIG. 7 depicts the first switch assembly as it continues transitioning from the first operating state (ON position) to the second operating state (OFF position);

FIG. 8 depicts the second switch assembly in a third operating state (RESET position);

FIG. 9 depicts the first switch assembly in the third operating state (RESET position);

FIG. 10 depicts the second switch assembly in a fourth operating state (TRIPPED position);

FIG. 11 depicts the first switch assembly in the fourth operating state (TRIPPED position);

FIG. 12 illustrates a common trip bar included in the staggering-contact airgap mechanism shown in FIG. 1 having off-set paddles according to a non-limiting embodiment of the present disclosure;

FIG. 13 illustrates a common trip bar included in the staggering-contact airgap mechanism shown in FIG. 1 having paddles with different thicknesses according to a non-limiting embodiment of the present disclosure;

FIG. 14 depicts the second switch assembly including a long-contact kicker operating in the first operating state (ON position);

FIG. 15 depicts the second switch assembly including the long-contact kicker transitioning from the first operating state (ON position) to the second operating state (OFF position);

FIG. 16 is a perspective view of a second switch assembly included in the staggering-contact airgap mechanism shown in FIG. 1 according to another non-limiting embodiment of the present disclosure;

FIG. 17 depicts the second switch assembly in a first operating state (ON position);

FIG. 18 depicts the second switch assembly transitioning from the first operating state (ON position) to a second operating state (OFF position); and

FIG. 19 depicts the second switch assembly in the second operating state (OFF position).

### DETAILED DESCRIPTION

A SSCB employs one or more airgap mechanisms (often referred simply as “airgaps”) and one or more contact systems (often referred to simply as “contacts”) to establish the physical separation between the line and load sides. The airgap mechanism and contact system are designed to be robust enough to operate without relying on the solid state power electronics and software to ensure the breaker is safe even in a scenario where the electronics are not functioning. This requirement poses a unique challenge for the design of these airgap systems, especially in the case of DC circuit or higher power applications where interruptions are harder to achieve with a simple contact system. During operation of the SSCB, an electrical arc can form across the airgap when the contact is opened. This arc can delay the circuit interruption and expose the load to damage. Repeated arcing events can also damage the contacts over time.

Various non-limiting embodiments of the present disclosure provide a staggering-contact airgap mechanism that can be implemented in a direct-current (DC) solid state circuit breaker. The staggering-contact airgap mechanism includes first and second contact assemblies that are configured to stagger the opening times of their respective airgaps. According to a non-limiting embodiment, the second switch assembly operates to open the second airgap at a first time. Operation of the second switch assembly in turn operates the first switch assembly to open the first airgap at a second time that is later than the first time. The staggered opening of the airgaps allows time for the solid-state electronics to work in tandem with the second contact assembly to open the second airgap and interrupt the current before the first airgap is opened, thus minimizing, or even completely preventing, the formation of arcs across the first and second airgaps.

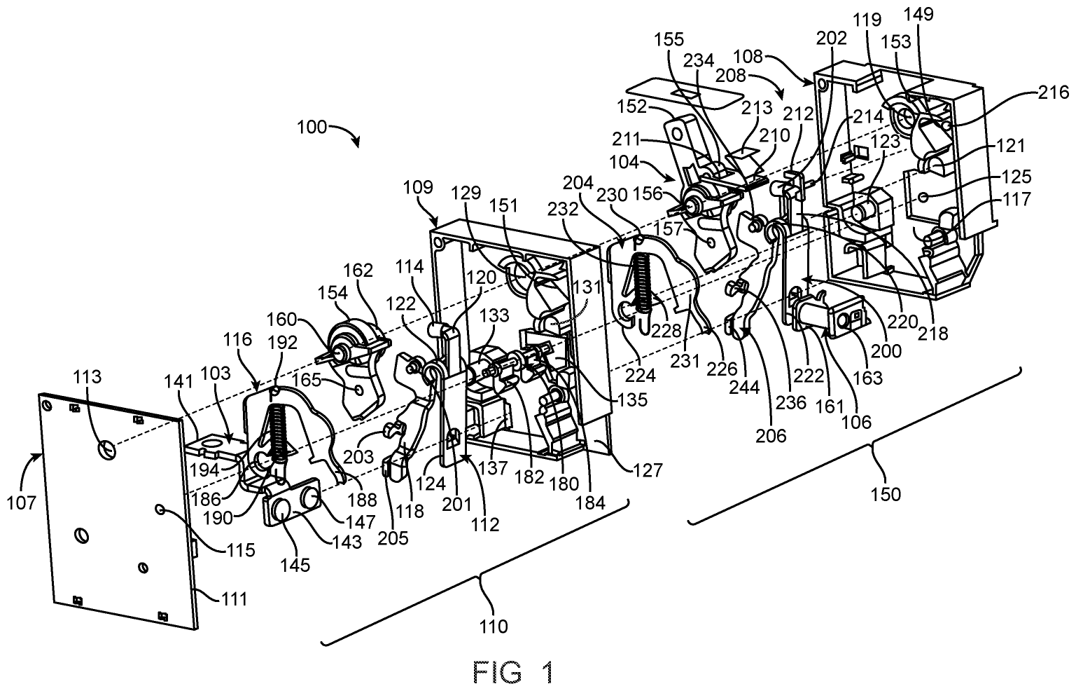

With reference now to FIG. 1, a direct current (DC) solid state circuit breaker mechanism (SSCBM) 100 including a staggering-contact airgap system is illustrated according to a non-limiting embodiment of the present disclosure. The DC SSCBM 100 includes a housing defined by a plurality of walls 107, 108, 109, a line terminal 103, a handle assembly 104, an electromagnet 106, a first switch assembly 110, and a second switch assembly 150.

The walls 107, 108, 109 may be formed from several molded housing portions. Some portions of the walls 107, 108, 109 are not shown to aid in understanding the novel and unobvious features of the DC SSCBM 100. The walls 107, 108, 109 may be made from any suitable rigid plastic, such as a thermoset plastic material (e.g., polyester), or other solid materials. Furthermore, the walls 107, 108, 109 are coupled together using various known methods. For example, the walls 107, 108, 109 can be snapped together, or coupled together using other means of fastening such as screws, plastic welding, and/or adhesive.

The walls defining the housing include a first wall 107, a second wall 108 opposite the first wall 107, and a mid-wall 109 interposed between the first wall 107 and the second wall 108. The first wall 107, mid-wall 109 and second wall 108 can interconnect with each other via snaping features, multiple fasteners (e.g., rivets), pegs, openings, and molded features to form the housing profile, surfaces, and internal spaces to contain, mount, and retain the other circuit breaker mechanism components. In addition, the various pegs, openings (e.g., bores, slots, etc.), and molded features described herein serve to support the components of the handle assembly 104, the first switch assembly 110, and the second switch assembly 150.

The first wall 107 has a first inner surface 111, which includes a hub bore 113 and a first-side bar slot 115. The second wall 108 has a second inner surface 117, which includes a handle bore 119, a second-side armature peg 121, a second-side cradle peg 123, a second-side bar slot 125, a second-side spring shelf 149, and a trip spring slot 153. The mid-wall 109 has an inner wall surface 127, which includes a mid-wall bore 129, a mid-wall armature peg 131, a mid-wall cradle peg 133, a bar opening 135, a contact slot 137, and a mid-wall spring shelf 151.

The bar opening 135 is configured to pass a trip bar 180 therethrough. The trip bar 180 extends between a first bar end and an opposing second bar end. The first bar end is disposed in the first-side bar slot 115 and the second bar end is disposed in the second-side bar slot 125. The trip bar 180 further includes one or more paddles 182 and 184. According to a non-limiting embodiment, the trip bar 180 is disposed through the bar opening 135 such that a first paddle 182 is located between the first wall 107 and the mid-wall 109 (i.e., in a first switch assembly chamber), while a second paddle 184 is located between the mid-wall 109 and the second wall 108 (i.e., in a second switch assembly chamber).

The housing further includes a terminal slot 139, which receives the line terminal 103. The line terminal 103 includes a tail end 141 and an opposing contact end 143. The tail end 141 extends from the terminal slot (not shown) and is located externally from the housing. The contact end 143 is located within the housing and is disposed through the contact slot 137 such that a first portion is located between the first wall 107 and the mid-wall 109, while a second portion is disposed between the mid-wall 109 and the second wall 108. The first portion of the contact end 143 includes a first contact pad 145 and the second portion of the contact end 143 includes a second contact pad 147. Although the first contact pad 145, the first switch assembly 110, the second contact pad 147, and the second switch assembly 150 are illustrated in a parallel arrangement to operate with a parallel current path scheme, it should be appreciated that the contact end 143 (e.g., the first contact pad 145), the first switch assembly 110, and the second switch assembly 150 can be assembled in a series arrangement to operate with a series current path scheme without departing from the scope of the inventive teachings. In a series arrangement, for example, a contact pad of the contact end 143 can be arranged in series with a contact of a first switch assembly (e.g., first switch assembly 110) and a second switch assembly (e.g., second switch assembly 150) can be connected in series with the first switch assembly. The switching opening times of the first and second switch assemblies can then be staggered as described herein.

The electromagnet 106 includes a switch end 161 and an opposing source end 163 configured to receive an electrical current. The switch end 161 is located proximate to the second switch assembly 150. The source end 163 can be located externally from the housing and is configured to receive an electrical current. In response to the electrical current, the electromagnet 106 produces an electromagnetic field. In one or more non-limiting embodiments, the electromagnet 106 can operate under the control of a hardware controller, which detects fault events (e.g., overcurrent events, overload events, short-circuit events, etc.), push to trip, and/or remote signal inputs. Accordingly, the controller can output the electrical current to produce the electromagnet field which can manipulate various components of the second switch assembly 150. In this manner, the electromagnet 106 can serve as a tripping mechanism as described in greater detail below.

The handle assembly 104 is configured to manually switch the DC SSCBM 100 between various operating states including, but not limited to, a first operating state (e.g., an ON position) and a second operating state (e.g., an OFF position) as described in greater detail below. The handle assembly 104 includes a handle 152, a handle hub 154, and a handle hook 155. The handle 152 extends externally from the housing (e.g., walls 107, 108 and 109) and can be manually gripped and moved into one or more positions. A first handle stub 156 is on one side of the handle 152, and a second handle stub (not shown) is on the opposite side of the handle 152. The first handle stub 156 is rotatably disposed in one end of the mid-wall bore 129 and the second handle stub is rotatably disposed in the handle bore 119 of the second wall 108.

A hub stub 160 is on one side of the handle hub 154 and a grooved cylinder 162 is on an opposing side of the handle hub 154. The grooved cylinder 162 is rotatably disposed in a second end the mid-wall bore 129 and is configured to rotate in clockwise (CW) direction and counterclockwise (CCW) direction. The hub stub 160 is rotatably disposed in the hub bore 113 of the first wall 107. The grooved cylinder 162 has a groove formed therein, which receives the first handle stub 156 to fix the handle 152 together with the handle hub 154. In this manner, manually moving the handle 152 (e.g., left, and right) rotates the grooved cylinder 162 in the clockwise (CW) direction and the counterclockwise (CCW) direction.

The first switch assembly 110 and the second switch assembly 150 are located within respective switch assembly chambers formed by the arrangement of the first wall 107, mid-wall 109, and second wall 108. Each of the first and second switch assemblies 110 and 150 operate to either establish physical contact with the contact end 143 of the line terminal 103 or establish separation from the contact end 143 of the line terminal 103. As described herein, the second switch assembly 150 not only operates to open an airgap between the second contact pad 147 and the second switch assembly 150 at a first time, but also induces mechanical operation of the first switch assembly 110 to open an airgap between the first contact pad 145 and the first switch assembly 110 at a second time that later than the first time. For example, the second switch assembly 150 is adjustable into an unlatched position that initiates separation of the second contact pad 147 at a first time. Unlatching the second switch assembly 150 then initiates adjustment of the first switch assembly 110 into an unlatched position that initiates separation of the first contact end 145 at a second time occurring later than the first time. This staggered operation of the first switch assembly 110 and the second switch assembly 150 staggers the opening times of the first and second contact ends 145 and 147, and thus the first and second airgaps, to minimize, or even completely prevent, the formation of arcs across the first and second airgaps.

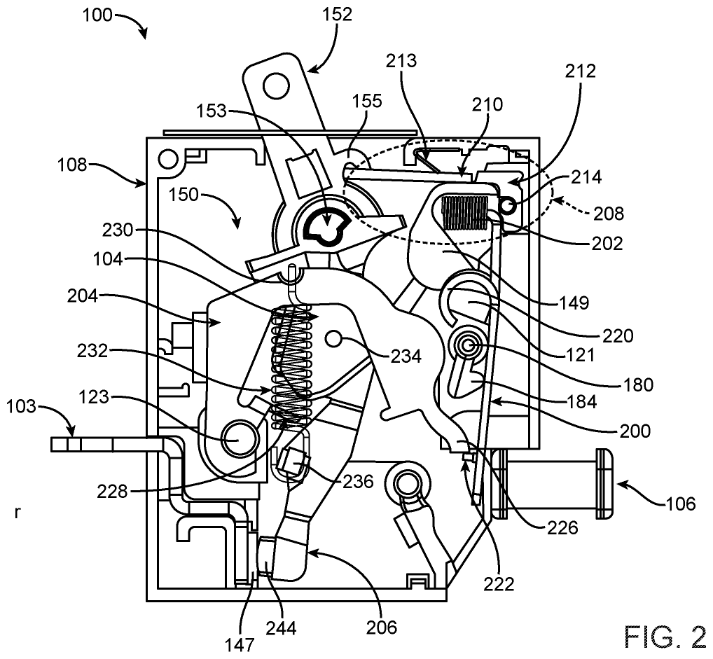

With continued reference to FIG. 1, along with FIGS. 2 through 6, the first switch assembly 110 includes a first armature 112, a first armature spring 114, a first cradle 116, and a first contact arm 118. The first armature spring 114 (see FIG. 6) is disposed in the mid-wall spring shelf 151. The first armature 112 includes a first flange 120, a first hook 122, and a first armature latch 124. The first armature latch 124 extends orthogonally from the first armature 112 at a set distance. The first flange 120 is disposed in the first armature spring 114 and the first hook 122 is rotatably disposed on the mid-wall armature peg 131. Accordingly, the first armature spring 114 forces the first armature 112 against the trip bar 180 (e.g., the first paddle 182) and places the first armature latch 124 in the engaging position with the first cradle 116, which establishes either an “ON” or “RESET” position of the first armature 112. When residing in the “ON” position, for example, the first cradle latching arm 188 of the first cradle 116 is disposed on the upper surface of the first armature latch 124.

The first cradle 116 includes a first cradle sleeve 186 (shown in FIG. 1), the first cradle latching arm 188, a first cradle kicker 190, and a first cradle spring slot 192. The first cradle sleeve 186 is rotatably disposed on the mid-wall cradle peg 133 to facilitate clockwise (CW) and counterclockwise (CCW) rotation of the first cradle 116. One end of a first switch spring 194 is coupled to the first cradle spring slot 192 while an opposing end of the first switch spring 194 is coupled to the first contact arm 118 to bias the first cradle 116 toward either an “OFF” position or “TRIP” position. Although a spring is described, it should be appreciated that the other types of elastic elements can be used to implement the first switch spring 194 without departing from the scope of the present disclosure.

The first contact arm 118 includes a first arm peg 201, a first spring clasp 203, and a first contact 205. The first arm peg 201 is pivotably disposed in a hub hole 165 formed in the handle hub 154 and the first spring clasp 203 is coupled to the second end of the first switch spring 194. In this manner, the first contact arm 118 is mechanically coupled to the handle hub 154 and can pivot via the first arm peg 201 in a clockwise (CW) direction and counterclockwise (CCW) direction. The first contact 205 is configured to establish physical contact and separation with the first contact pad 145 in response to pivoting the first contact arm 118.

With continued reference to FIGS. 1 and 2, the second switch assembly 150 includes a second armature 200, a second armature spring 202, a second cradle 204, a second contact arm 206, and a trip linkage 208. The trip linkage 208 is configured to adjust movement of the first armature 112 in response to moving the handle 152. According to a non-limiting embodiment, the trip linkage 208 includes a trip beam 210, a trip cam 212, and a trip spring 213. The trip spring 213 is disposed in the trip spring slot 153 formed in the second wall 108. A first end of the trip beam 210 includes a hook slot 211 which receives the handle hook 155 to establish a pivot. The opposing second end of the trip beam 210 contacts the trip cam 212 and is pressed thereagainst by the trip spring 213. The trip cam 212 is coupled to one end of a cam shaft 214. The opposing end of the cam shaft 214 is rotatably disposed in a cam shaft slot 216 formed in the second wall 108. Accordingly, adjusting the handle 152 (e.g., left, or right) moves the trip beam 210 in a horizontal direction, which in turn rotates the trip cam 212 (e.g., in a clockwise (CW) direction and counterclockwise (CCW) direction).

The second armature spring 202 is disposed in the second-side spring shelf 149. The second armature latch 222 extends orthogonally from the second armature 200 at a set distance. According to one or more non-limiting embodiments, the second armature 200 is formed from an magnetically attractive material including, but not limited to, metal. In this manner, the second armature 200 can be magnetically attracted toward the electromagnet 106 when the electromagnet 106 generates an electromagnetic field.

The second armature 200 includes a second flange 218, a second hook 220, and a second armature latch 222. The second flange 218 is disposed in the second armature spring 202 and the second hook 220 is rotatably disposed on the second-side armature peg 121. Accordingly, the second armature spring 202 forces the second armature 200 against the trip bar 180 (e.g., the second paddle 184), and places the armature latch 124 in the engaging position with the second cradle latching arm 226 which establishes either an “ON” position or a “RESET” position of the second armature 200.

The second cradle 204 includes a second cradle sleeve 224, a second cradle latching arm 226, a second cradle kicker 228, a second cradle spring slot 230, and a cradle tippet 231. The second cradle sleeve 224 is rotatably disposed on the second-side cradle peg 123 to facilitate clockwise and counterclockwise rotation of the second cradle 204. One end of a second switch spring 232 is coupled to the second cradle spring slot 230 while an opposing end of the second switch spring 232 is coupled to the second contact arm 206 to bias the second cradle 204 in an “ON” position. When residing in the “ON” position, for example, the second cradle latching arm 226 is disposed on the upper surface of the second armature latch 222. Although a second switch spring 232 is described herein, it should be appreciated that the other types of elastic elements can be used to implement the second switch spring 232 without departing from the scope of the present disclosure.

The second contact arm 206 includes a second arm peg 234, a second spring clasp 236, and a second contact 244. The second arm peg 234 is pivotably disposed in a handle hole 157 formed in the handle 152 and the second spring clasp 236 is coupled to the second end of the second switch spring 232. In this manner, the second contact arm 206 is mechanically coupled to the handle 152 and can pivot via the second arm peg 234 in a clockwise (CW) direction and a counterclockwise (CCW) direction. The second contact 244 is configured to establish physical contact with the second contact pad 147 and physical separation with the second contact pad 147 in response to pivoting the second contact arm 206.

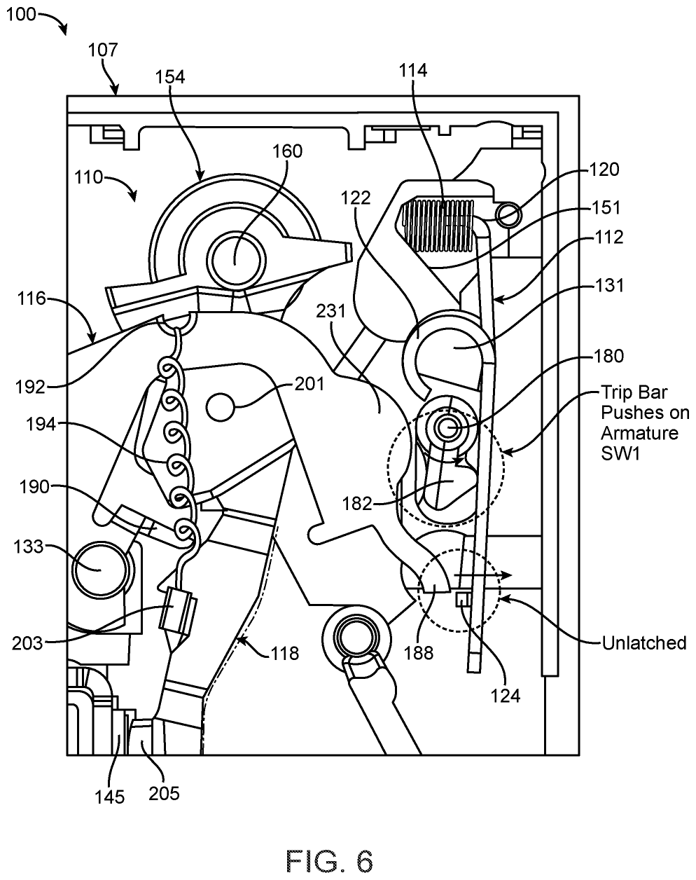

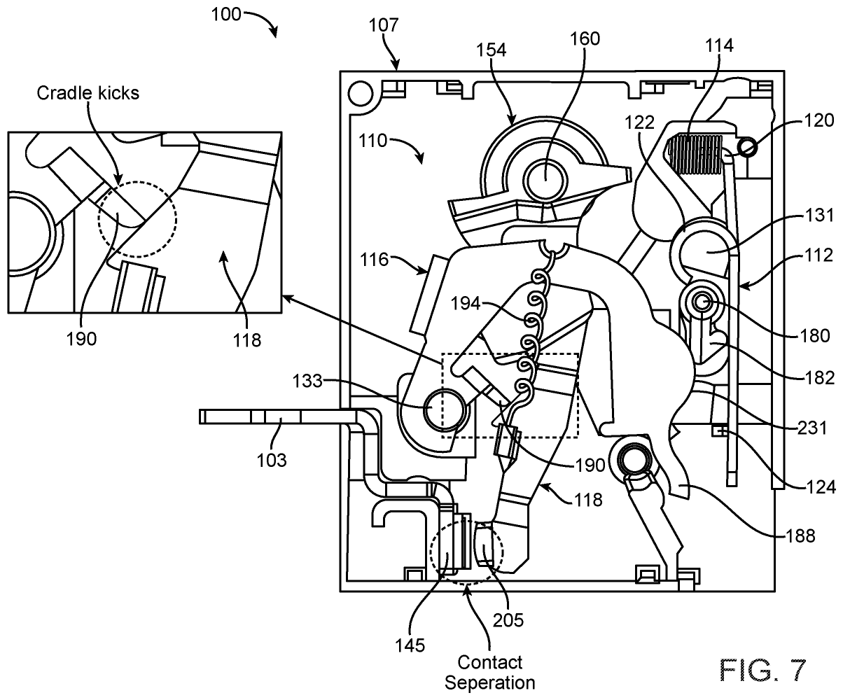

With continued reference to FIGS. 2-6 along with FIGS. 7-11, operation of the DC SSCBM 100 is described according to a non-limiting embodiment of the present disclosure. FIG. 2 is a sideview showing the handle assembly 104 and the second switch assembly 150 of the DC SSCBM 100 in a first operating state (e.g., “ON” position). When residing in the first operating state (e.g., ON position), the second cradle latching arm 226 is disposed on the upper surface of the second armature latch 222 and the second contact 244 physically contacts the second contact pad 147. Accordingly, an electrically conductive circuit path is established between the line side (e.g., the line terminal 103) and the load side (e.g., a connected load).

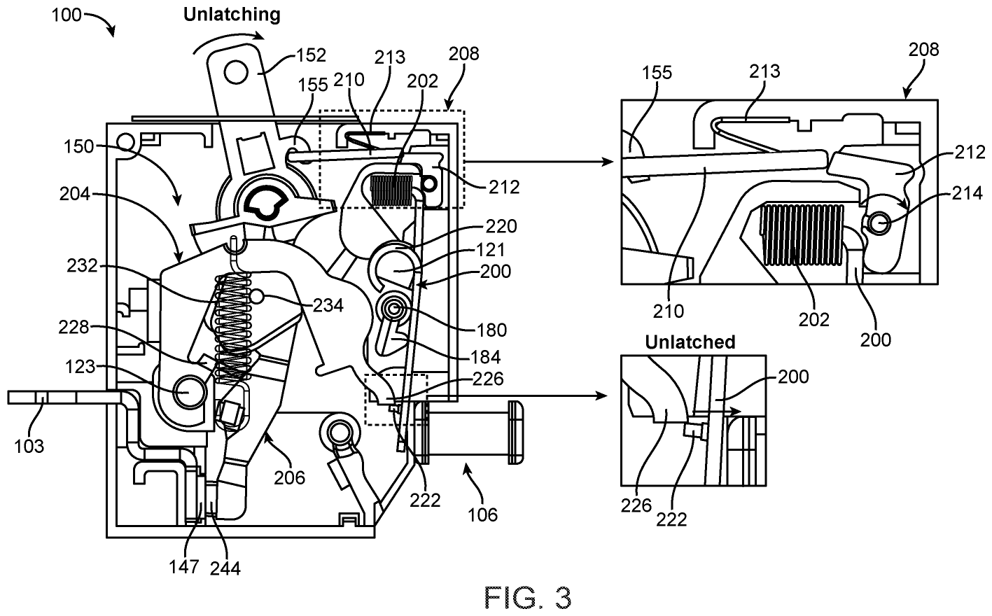

Turning to FIG. 3, the DC SSCBM 100 is shown transitioning from the first operating state (e.g., ON position) to a second operating state (e.g., OFF position). The transition from the first operating state (e.g., ON position) to the second operating state (e.g., OFF position) adjusts the second switch assembly 150 in a manner that ensures the physical separation between the second contact 244 and the second contact pad 147 occurs before the physical separation between the first contact 205 and the first contact pad 145.

As shown in FIG. 3, moving the handle 152 from the ON position toward the OFF position causes the trip beam 210 to slide toward the second armature 200 and push or “cam” against the trip cam 212. The pushing force rotates the trip cam 212 in a clockwise (CW) direction on the cam shaft 214 causing it to press against an upper portion of the second armature 200. The resulting pressing force applied by the trip cam 212 causes the second armature 200 to rotate counterclockwise (CCW), which moves the upper surface of the second armature latch 222 away from the contact surface of the second cradle latching arm 226.

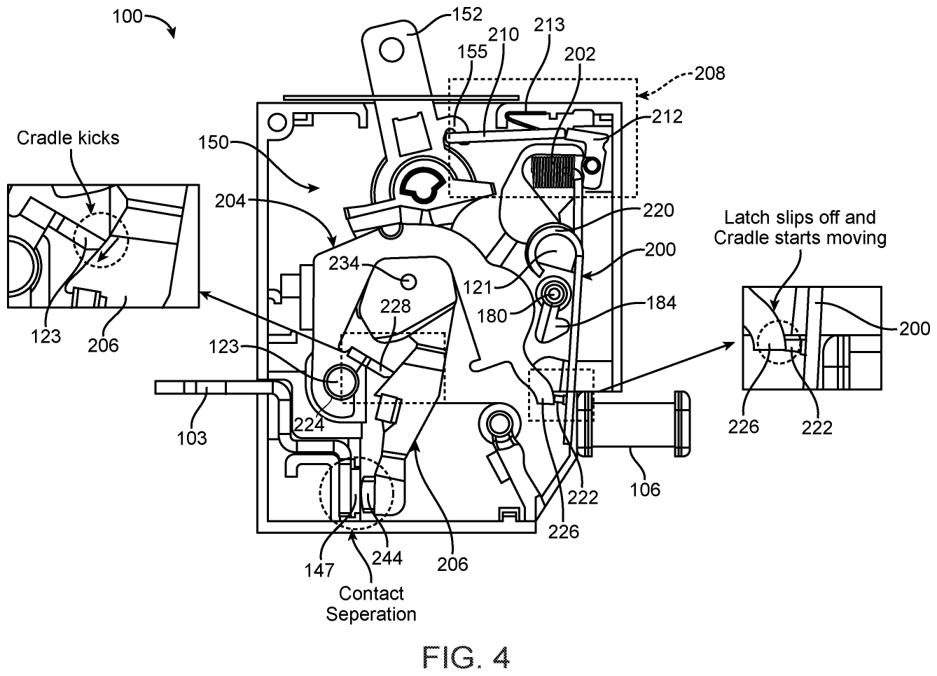

Turning to FIG. 4, the continued CCW movement of the armature 200 causes the second cradle latching arm 226 to slip off the upper surface of the second armature latch 222 and unlatches the second cradle 204 from the second armature 200. Unlatching the second cradle 204 allows the second switch spring 232 (removed in FIG. 4 for clarity) to force a CW rotational movement of the second cradle 204 about the second cradle sleeve 224 and the second-side cradle peg 123, which causes the second cradle kicker 228 to contact and slide against the second contact arm 206. As a result, the second contact arm 206 is forced away from the line terminal 103 such that the second contact 244 is physically separated from the second contact pad 147 to establish the respective second airgap therebetween.

As described herein, various components can be changed or modified to calibrate (e.g., “fine tune”) the staggered separation timing of the first and second contacts 205 and 244. For example, the set distance of the second armature latch 222 can be specifically designed to control the time at which the second cradle latching arm 226 slips off the second armature latch's upper surface. In another example, the length of the second cradle kicker 228 can be modified to control the time at which it contacts the second contact arm 206. For example, increasing the length of the second cradle kicker 228 will shorten the time at which it contacts the second contact arm 206 while reducing the length of the second cradle kicker 228 will increase the time at which it contacts the second contact arm 206. In either case, the overall time at which the second contact 244 is physically separated from the second contact pad 147 can be calibrated (e.g., fine-tuned).

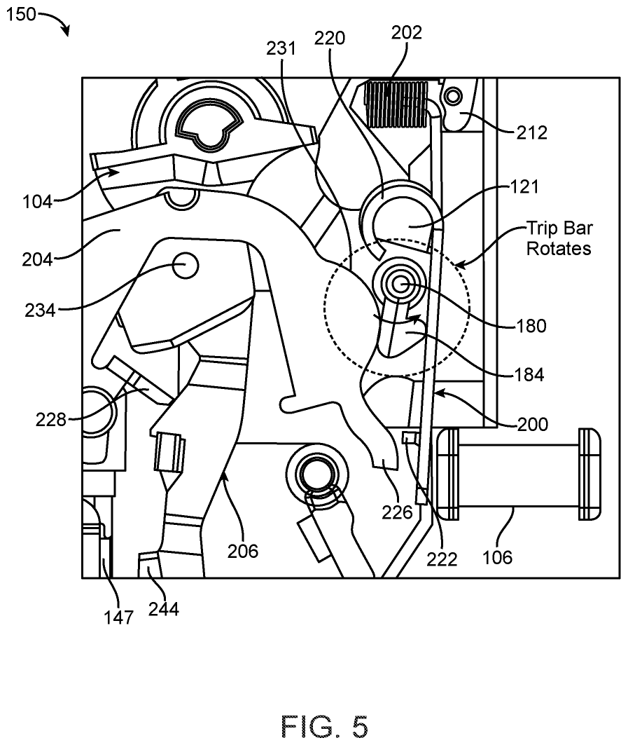

Turning now to FIG. 5, the second switch assembly 150 is shown as the second cradle 204 is unlatched from the second armature 200. The CW rotational movement of the second cradle 204 cause the cradle tippet 231 to press against the second paddle 184, and in turn rotates the trip bar 180 in a CCW direction. The rotation of the trip bar 180 causes the mutual rotation of the first paddle 182 located in the first switch chamber, which is described in greater detail below.

FIG. 6 shows depicts a sideview of first switch assembly 110 as it transitions from the first operating state (e.g., ON position) to the second operating state (e.g., the OFF position) according to a non-limiting embodiment of the present disclosure. The movement of the handle 152 induces unlatching of the first armature 112 by rotating the first paddle 182 in the CCW direction such that it to press against the first armature 112. The resulting pressing force rotates the first armature 112 in a counterclockwise (CCW) direction, which moves the upper surface of the first armature latch 124 away from the contact surface of the first cradle latching arm 188 and unlatches the first cradle 116 from the first armature 112. According to a non-limiting embodiment, the set distance at which the first armature latch 124 extends from the first armature 112 can be adjusted (e.g., shorter, or longer with respect to the second armature latch 222), which controls or “fine tunes” the time at which first armature 112 separates from the first cradle latching arm 188. In this manner, the time at which initiating separation of the first contact 205 from the first contact pad 145 can be calibrated or “fine-tuned.”

Referring to FIG. 7, unlatching the first cradle 116 allows the first switch spring 194 to force a CW rotational movement of the first cradle 116 about the first cradle sleeve 186 and first-side cradle peg 133. The first cradle kicker 190 is then forced to slide against the first contact arm 118 and move it away from the line terminal 103. As a result, the first contact 205 is physically separated from the first contact pad 145 to establish the respective first airgap therebetween. As described above, the set distance of the first armature latch 124 can be specifically designed to control the time at which the first cradle latching arm 188 slips off the first armature latch's upper surface. In another example, the length of the first cradle kicker 190 can be modified to control the time at which it contacts the first contact arm 118. For example, increasing the length of the first cradle kicker 190 will shorten the time at which it contacts the first contact arm 118 while reducing the length of the first cradle kicker 190 will increase the time at which it contacts the first contact arm 118. In either case, the modifications or changes to the components can calibrate (e.g., fine-tune) the overall time at which the first contact 205 is physically separated from the first contact pad 145.

As described herein, the separation between the first contact 205 and the first contact pad 145 occurs later than the separation between the second contact 244 and the second contact pad 147. In this manner, the electronics can work in tandem with the airgap system to minimize or even completely avoid arcing.

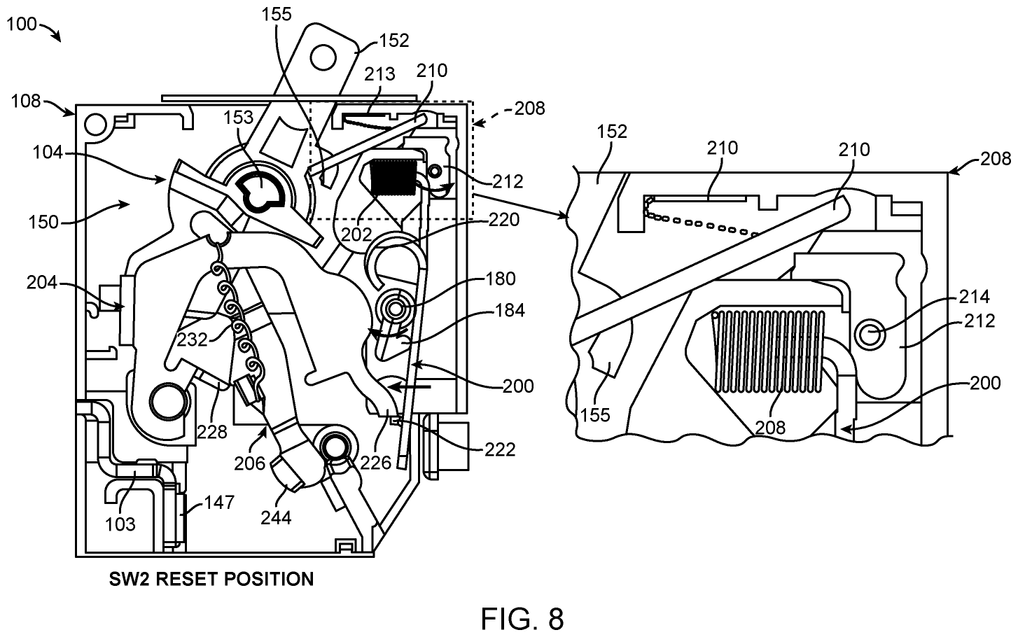

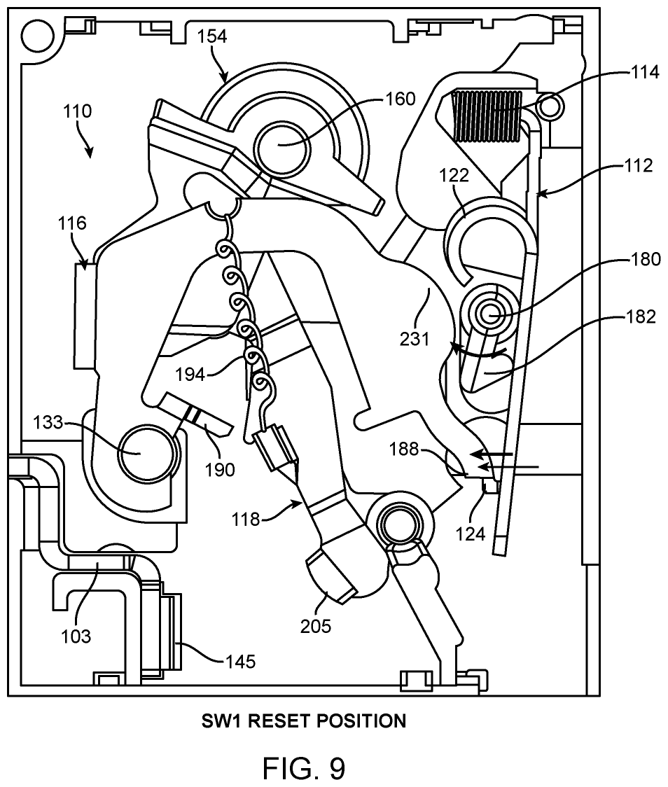

Referring now to FIGS. 8 and 9, the DC SSCBM 100 is shown existing in a third operating state (e.g., RESET position). As shown in FIG. 8, the third operating state (e.g., RESET position) is invoked in response to the continued movement of the handle 152 toward the second armature 200 until it reaches a resting point. As the handle 152 moves toward its resting position, the trip beam 210 pivots upward and lifts off of the trip cam 212 to allow the trip cam 212 to rotate in a CCW direction. At the same instance, the second armature 200 moves back toward the second cradle 204 such that the second cradle latching arm 226 is re-positioned on the upper surface of the second armature latch 222 and latched (e.g., re-latched) to reset the second switch assembly 150 as shown in FIG. 8. Likewise, FIG. 9 illustrates the first armature 112 after it has moved back toward the first cradle 116 such that the first cradle latching arm 188 is re-positioned on the upper surface of the first armature latch 124 and latched (e.g., re-latched) to reset the first switch assembly 110.

As described herein, adjustment of the second switch assembly 150 induces adjustment of the first switch assembly 110. Since the handle 152 is moveably coupled the handle hub 154, their rotation in a CW direction by an external force causes the bottom portion of the handle 152 to cam with the second cradle 204 moving it in a CCW direction, and the bottom portion of the handle hub 154 to cam with the first cradle 116 moving it in a CCW direction. The first and second armature springs 114 and 202 move the first and second armatures 112 and 200 back into the RESET position as shown in FIG. 9. The SSCBM 100 can then be subsequently returned to the ON position using the handle 152.

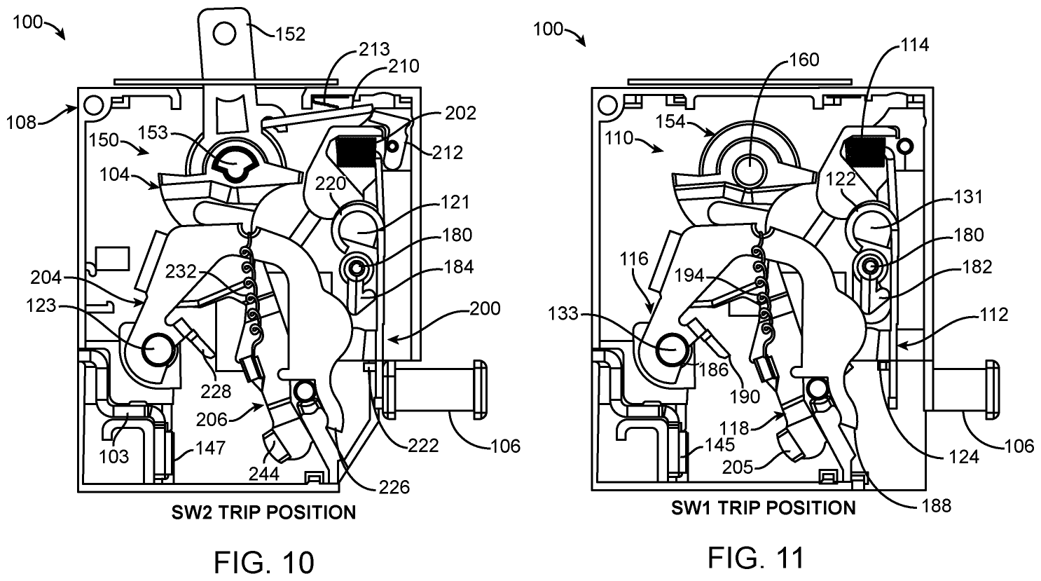

Turning now to FIGS. 10 and 11, the DC SSCBM 100 is shown operating in a fourth operating state (e.g., TRIP position). As described herein, the electromagnet 106 operates under the control of a hardware controller (not shown) programmed with software algorithms configured to detect faults (e.g., overcurrent events, overload events, short-circuits, etc.), to receive commands from push to trip, or a remote trip signal. In response to detecting a fault event, the controller outputs a drive current, which energizes the electromagnet 106. In any case, the energized electromagnet 106 generates an electromagnet field, which magnetically attracts the second armature 200 and forces it away from the second cradle 204.

FIG. 10 shows the second switch assembly 150 in the TRIP position. The magnetic force produced by the electromagnet 106 is realized by the armature 200 thereby moving it in a CCW direction and unlatches it from the cradle 204, allowing the cradle 204 to rotate in a CW direction due to the force applied by the second switch spring 232. During this rotation, the cradle 204 cams with the second paddle 184, causing the trip bar 180 to rotate in a CCW direction and allowing the contact arm 206 to move away from the line terminal 103. As a result, the second contact 244 is physically separated from the second contact pad 147 to establish the respective second airgap.

FIG. 11 shows the first switch assembly 110 in the TRIP position caused by the adjustment of the second switch assembly 150. As described herein, CCW rotation of the trip bar 180 causes a CCW rotation of the first paddle 182, which in turn pushes the first armature 112 away from the first cradle 116 and unlatches the first cradle latching arm 188 from the first armature latch 124. The first switch spring 194 then forces a CW rotational movement of the first cradle 116 about the first cradle sleeve 186 and the second-side cradle peg 123 and allows the first contact arm 118 to move away from the line terminal 103. As a result, the first contact 205 is physically separated from the first contact pad 145 to establish the respective first airgap. The handle 152 can then be manually adjusted into the RESET position to place the first and second switch assemblies 110 and 150 into their respective RESET positions as described above (See FIGS. 8 and 9).

While the present disclosure has been described above by reference to various non-limiting embodiments, it should be appreciated that various changes and modifications can be made to one or more of the components and/or assemblies without departing from the scope of the inventive teachings. In some non-limiting embodiments, the changes and/or modifications of the components can calibrate or fine tune the contact separation timings of the first and second contacts 205 and 244 as described in further detail below.

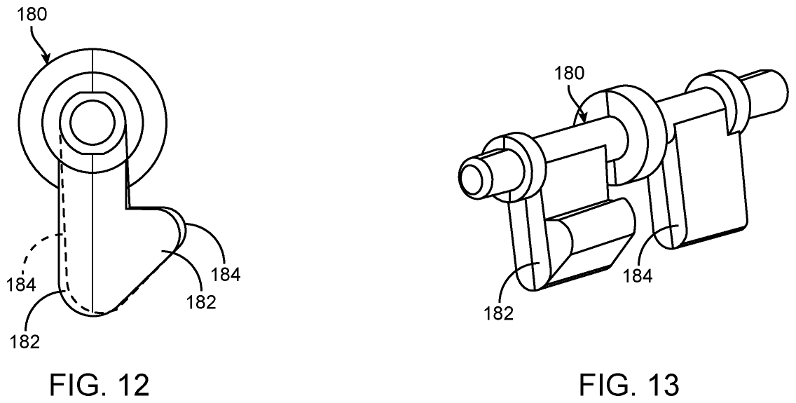

FIG. 12, for example, illustrates a non-limiting modification to the first and second paddles 182 and 184 of the trip bar 180. In this example, the trip bar 180 is shown to include off-set first and second paddles 182 and 184. The first paddle 182 is off-set to “lag” behind the second paddle 184, which alters the cam timings of the first and second cradles 116 and 204 with the first and second paddles 182 and 184, respectively. For example, increasing the off-set of the first paddle 182 (i.e., the distance at which the first paddle 182 lags behind the second paddle 184) causes the first and second paddles 182 and 184 to interact with the first cradle 116, the second cradle 204, the first armature 112, and the second armature 200 at different positions or angles with respect to one another. In this manner, off-setting the first paddle 182 with respect to the second paddle 184 can calibrate (e.g., fine-tune) the delay time (e.g., increase or decrease the delay time) at which the first contact 205 is physically separated from the first contact pad 145 following the separation of the second contact 244 from the second contact pad 147.

FIG. 13 illustrates another example modification to the trip bar 180. In this example, the thickness of the second paddle 184 (shown for example as a flat face) is less than the thickness of the first paddle 182 (shown for example as a protrusion) to apply a “dampening” or resistance to the rotational movement of the trip bar 180. It should be appreciated that the reduced thickness of the second paddle 184 is not required to be a flat face, but rather simply needs to be less than the thickness of the first paddle 182. For example, reducing the thickness of the second paddle 184 with respect to the first paddle 182 increases the rotational speed of the trip bar 180 while increasing the thickness of the second paddle 184 decreases the rotational speed of the trip bar 180. In this manner, the time at which the first switch assembly 110 is unlatched can be controlled, thereby allowing for calibration (e.g., fine-tuning) of the delay time at which the first contact 205 is physically separated from the first contact pad 145.

According to another non-limiting embodiment, a dampening effect can be applied to the trip bar 180 using the armature spring 202. For example, the armature spring 202 constantly exerts a force on the second armature 200 and produces a CW moment thereon. By forming the trip bar paddle 184 with a target thickness, the trip-bar's CCW motion will be dampened by the second armature's 200 inertia and the CW moment created by the armature spring 202. It should be appreciated various types of springs including, but not limited to, a torsion spring, extension spring, compression spring, and leaf spring, can be used to resist or dampen the free movement of the trip bar 180.

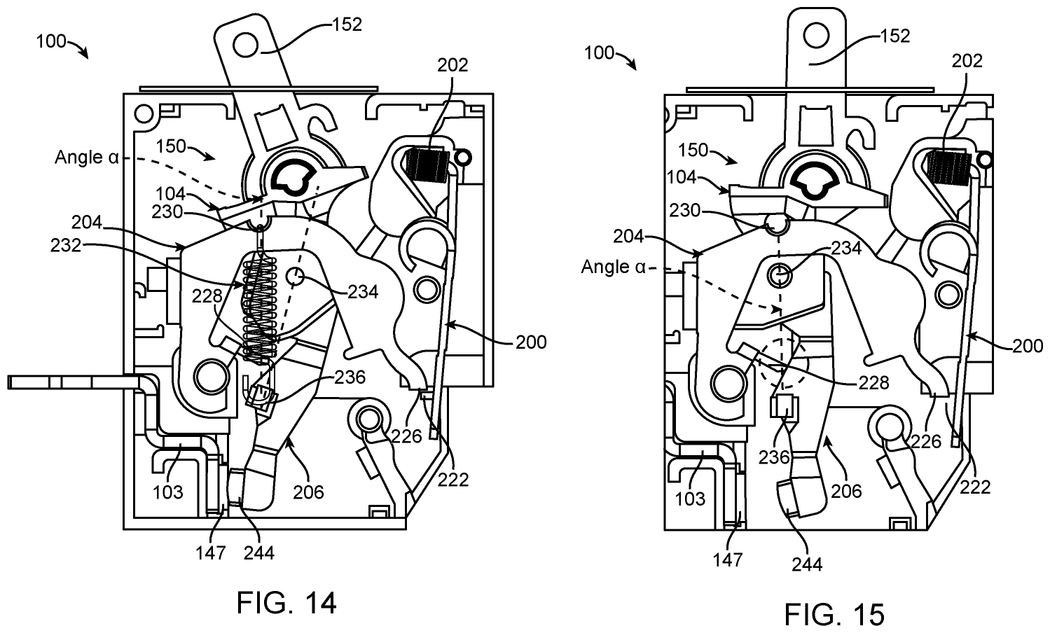

FIGS. 14-15 illustrate another example of calibrating or fine-tuning the staggered contact separation times by modifying the “over-center” positions of the first switch assembly 110 and/or the second switch assembly 150. Although the second switch assembly 150 is shown in FIGS. 14-15, it should be appreciated that similar modifications can be applied to the first switch assembly 110 without departing from the scope of the invention.

Referring to FIG. 14, the “over-center” position is based on an angle (a) that is established between a first axis representing the elastic force (e.g., spring force) of the second switch spring 232 (e.g., by the second switch spring 232) extending from spring clasp 236 to the cradle spring slot 230) and a second axis extending from the spring clasp 236 through the arm peg 234.

As shown in FIG. 15, over-center occurs when angle (a) becomes zero (represented in FIG. 15 by a straight line going extending through the spring clasp 236, the arm peg 234, and the cradle spring slot 230). Accordingly, the second contact arm 206 is biased (e.g., by the second switch spring not shown in FIG. 15) toward the ON position (e.g., toward the second contact pad 147) such that the second cradle kicker 228 contacts the second contact arm 206 when the angle (a) is positive, and is biased toward the OFF position (e.g., toward the second armature 200) when the angle (a) is negative. Thus, a larger angle (a) will result in later contact opening while a smaller angle (a) will result in an earlier contact opening.

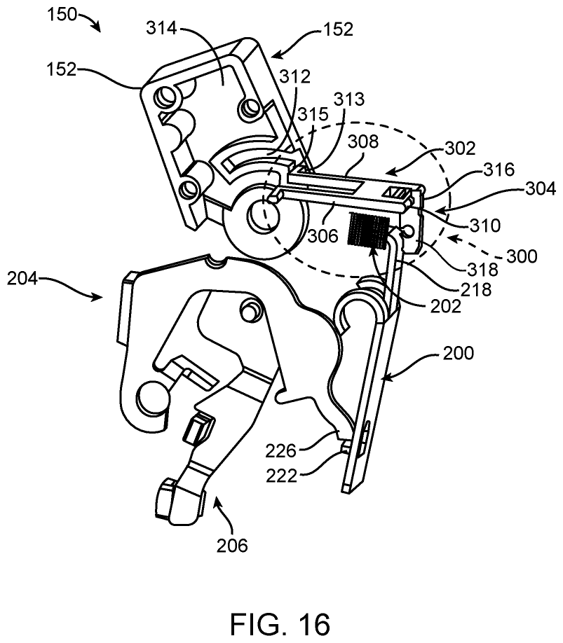

Turning now to FIGS. 16-19, a trip linkage 300 capable of implementation in the DC SSCBM 100 is illustrated according to another non-limiting embodiment of the present disclosure. The trip linkage 300 operates in tandem with the handle assembly 104 and the second armature 200 in a similar manner to the trip linkage 208 discussed in detail above. Therefore, detailed operations of the handle assembly 104 and the second armature 200 will not be repeated for the sake of brevity.

Referring to FIG. 16, the trip linkage 300 includes a slidable link 302 and a pivoting link 304. The slidable link 302 has a pair of opposing link legs 306, 308, and a rod 310 extending between the link legs 306 and 308. A first link leg 306 is slidably disposed in a first cam slot 312 formed on a first inner side 314 of the handle 152, while the second link leg 308 is slidably disposed in a second cam slot (not shown) formed on a second inner side (not shown) of the handle 152 opposite the first inner side 314. In one or more non-limiting embodiments, a leg groove 313 and a groove shoulder 315 assist in supporting the slidable link 302 when operating in the first operating state (e.g., ON position).

A first end 316 of the pivoting link 304 is pivotably coupled to the rod 310, while the opposing second end 318 of the pivoting link 304 is coupled to the second armature 200. In one or more non-limiting embodiments, the first end 316 of the pivoting link 304 includes a clip that is pivotably coupled to the rod 310, while the opposing second end 318 of the pivoting link 304 serves as a bumper that is pressed against the second flange 218 of the second armature 200.

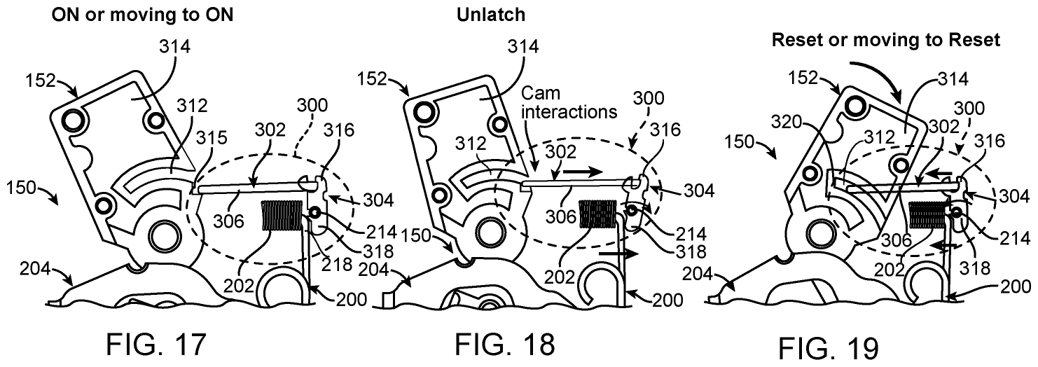

Turning to FIG. 17, the handle 152 and the trip linkage 300 are shown existing in the first operating position (e.g., ON position). The first and second link legs 306 and 308 are disposed in the leg grooves 313 and against the groove shoulder 315. Accordingly, the second armature 200 can be latched to the second cradle 204.

FIG. 18 shows the handle 152 and the trip linkage 300 transitioning from the first operating state (ON position) to the second operating state (OFF position). As the handle 152 is moved into the OFF position (e.g., moved toward the second armature 200), the groove shoulders 315 press against the first and second link legs 306 and 308, which in turn rotates the pivoting link first end 316 in a CW direction. The rotation of the pivoting link 304 causes the pivoting link second end 318 to force the second armature 200 (e.g., the second armature latch 222) away from the second cradle 204 (e.g., the second cradle latching arm 226) and unlatch the second cradle 204.

Turning to FIG. 19, the handle 152 and the trip linkage 300 are shown transitioning into the third operating state (RESET position). The RESET position is invoked by continuing to move handle 152 toward the second armature 200 until it reaches the handle rest position. As the handle 152 is moved toward the rest position, the first and second link legs 306 and 308 are guided into the cam slots 312 and slide therein until stopping against the slot wall 320 to affect the RESET position. As the slidable link 302 moves toward the slot wall 320, the armature spring 202 forces the armature 200 to rotate CW toward the second cradle latching arm 226 to latch the second cradle 204, which also cams and rotates the pivoting link 304 in a CCW direction. Accordingly, the SSCBM 100 is now in the RESET position.

It is to be understood that the elements and features recited in the appended claims may be combined in different ways to produce new claims that likewise fall within the scope of the present invention. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description. Independent of the grammatical term usage, individuals with male, female or other gender identities are included within the term.

What is claimed is:

1. A direct current (DC) solid state circuit breaker mechanism (SSCBM) comprising:
a first switch assembly configured to selectively close a first airgap and open the first airgap;
a second switch assembly configured to selectively close a second airgap and open the second airgap,
wherein the second switch assembly is adjustable into an unlatched position to open the second airgap at a first time, and
wherein unlatching the second switch assembly initiates adjustment of the first switch assembly into an unlatched position to open the first airgap at a second time that is later than the first time.

2. The DC SSCBM of claim 1, wherein the first switch assembly and the second switch assembly are connected in series.

3. The DC SSCBM of claim 1, wherein the second switch assembly and the second switch assembly are connected in parallel.

4. The DC SSCBM of claim 3, wherein:
the first switch assembly comprises:
a handle hub configured to rotate in a first rotational direction and a second rotational direction opposite the first rotational direction;
a first contact arm coupled to the handle hub;
a first cradle coupled to the first contact arm; and
a first armature configure to latch and unlatch with the first cradle; and
the second switch assembly comprises:
a handle coupled to the handle hub, the handle configured to move in a first direction from a first position to a second position and a second direction from the second position to the first position so as to rotate the handle hub in the first and second rotational directions;
a second contact arm coupled to the handle;
a second cradle coupled to the second contact arm; and
a second armature configure to latch and unlatch with the second cradle;
wherein adjusting the second switch assembly into the unlatched position to unlatch the second armature from the second cradle initiates opening of the second airgap at the first time, and induces adjustment of the first switch assembly into the unlatched position to unlatch the first armature from the first cradle and initiate opening of the first airgap at the second time.

5. The DC SSCBM of claim 4, further comprising a trip bar configured to rotate in the first and second rotational directions, the trip bar including a first paddle configured to contact the first armature and a second paddle configured to cam with the second cradle.

6. The DC SSCBM of claim 5, wherein the trip bar rotates in the second direction in response to the second paddle camming with the second cradle, and wherein the first paddle contacts the first armature to initiate unlatching the first armature from the first cradle in response to rotating the trip bar in the second direction.

7. The DC SSCBM of claim 6, wherein the second switch assembly further comprises a trip linkage configured to adjust the second armature into the unlatched position which unlatches it from the second cradle in response to unlatching the second armature from the second cradle.

8. The DC SSCBM of claim 7, wherein:
the first contact arm rotatably pivots in the first rotational direction and the second rotational direction, the first contact arm including a first contact configured to physically contact a first contact pad to close the first airgap and to separate from the first contact pad to open the first airgap; and
the second contact arm rotatably pivots in the first rotational direction and the second rotational direction, the second contact arm including a second contact configured to physically contact a second contact pad to close the second airgap and to separate from the second contact pad to open the second airgap.

9. The DC SSCBM of claim 8, wherein:
in response to unlatching the second armature, the second cradle forces the second contact arm to pivot in the second rotational direction such that the second contact opens the second airgap at the first time; and
in response to unlatching the first armature, the first cradle forces the first contact arm to pivot in the first rotational direction such that the first contact opens the first airgap at the second time.

10. The DC SSCBM of claim 9, wherein:
the first cradle includes a first cradle kicker configured to contact the first contact arm and pivot it in the second rotational direction; and
the second cradle includes a second cradle kicker configured to contact the second contact arm and pivot it in the second rotational direction.

11. The DC SSCBM of claim 4, wherein moving the handle from the first position toward the second position unlatches the second armature from the second cradle and induces the first armature to unlatch from the first cradle to establish an OFF position.

12. The DC SSCBM of claim 4, wherein the second armature is configured to unlatch from the second cradle in response to realizing an electromagnetic force so as to induce the first armature to unlatch from the first cradle to establish a TRIP position.

13. The DC SSCBM of claim 12, wherein moving the handle into a RESET position latches the second armature with the second cradle and latches the first armature with the first cradle.

14. The DC SSCBM of claim 13, wherein moving the handle from the RESET position to the first position pivots the second contact arm in the first rotational direction such that the second contact closes the second airgap, and pivots the first contact arm in the first rotational direction such that the first contact closes the first airgap.

15. The DC SSCBM of claim 4, wherein:
the first armature includes a first armature latch extending therefrom at a first distance and configured to latch the first armature with the first cradle; and
the second armature includes a second armature latch extending therefrom at a second distance and configured to latch the second armature with the second cradle.

16. The DC SSCBM of claim 15, wherein the first distance of the first armature latch is different than the second distance of the second armature latch.

17. The DC SSCBM of claim 5, wherein the first paddle has a first thickness, and the second paddle has a second thickness different than the first thickness.

18. The DC SSCBM of claim 5, wherein the first paddle and the second paddle are disposed on the trip bar at off-set positions with respect to one another.

19. The DC SSCBM of claim 4, further comprising:
an elastic element having a first end coupled to the second cradle at a first coupling point and an opposing second end coupled to the second contact arm at a second coupling point, the elastic element exerting an elastic force on the second cradle and the second contact arm along a first axis; and
an arm peg on which the handle is pivotably disposed to move in the first and second rotational directions,
wherein a second axis extends from the arm peg and the second coupling point, and
wherein an angle extends between the first axis and the second axis, the angle defining an over-center position that sets the first time at which the second airgap is opened and sets the second time at which the first airgap is opened.

20. A direct current (DC) solid state circuit breaker mechanism (SSCBM) comprising:
a first switch assembly configured to selectively close a first airgap and open the first airgap, the first switch assembly including a first armature configured to be adjusted into a first unlatched position which unlatches it from a first cradle to open the first airgap; and
a second switch assembly configured to selectively close a second airgap and open the second airgap, the second switch assembly including a trip linkage configured to adjust a second armature into a second unlatched position which unlatches it from a second cradle to open the second airgap at a first time period,
wherein adjusting the second armature into the second unlatched position induces adjustment of the first armature into the first unlatched position to open the first airgap at a second time period that is later than the first time period.
